(19) United States
(12) Patent Application Publication
(10) Pub. No.: US 2024/0121185 A1
(43) Pub. Date: Apr. 11, 2024

(54) HARDWARE DISTRIBUTED ARCHITECTURE

(71) Applicant: MaxLinear, Inc., Carlsbad, CA (US)

(72) Inventors: Isaac Sitton, Petah Tikva (IL); Ingo Volkening, Singapore (SG); Oren Bakshe, Petah Tikva (IL)

(73) Assignee: MaxLinear, Inc., Carlsbad, CA (US)

(21) Appl. No.: 18/484,428

(22) Filed: Oct. 10, 2023

Related U.S. Application Data
(60) Provisional application No. 63/378,978, filed on Oct. 10, 2022.

(51) Int. Cl. H04L 45/00; H04L 45/42

(52) U.S. Cl. CPC H04L 45/566; H04L 45/42

(57) ABSTRACT

A network processing system includes an interface connection to obtain a packet. The network processing system also includes one or more packet processing components individually connected to a system communication channel. The one or more packet processing components are individually configured to perform a packet processing operation to the packet. The network processing system also includes a queueing system connected to the system communication channel. The queueing system determines a processing path of the packet from the interface connection and through the one or more packet processing components. The one or more packet processing components are individually configured to direct the packet to a next component using the processing path.

### CROSS REFERENCE TO RELATED APPLICATIONS

This U.S. patent application claims priority to U.S. Provisional Patent Application No. 63/378,978, titled “HARDWARE DISTRIBUTED ARCHITECTURE,” and filed on Oct. 10, 2022, the disclosure of which is hereby incorporated by reference in its entirety.

### TECHNICAL FIELD

This disclosure generally relates to a distributed hardware architecture, and more specifically, to a distributed hardware architecture for network processing.

### BACKGROUND

Unless otherwise indicated herein, the materials described herein are not prior art to the claims in the present application and are not admitted to be prior art by inclusion in this section.

Demand for network processing is constantly growing and often needs a long-term engineering solution. For example, network processing may deal with various challenges directed to needs of a network processing system including increased performance, scaling based on utilization thereof, interoperability, functional flexibility, power efficiency, and/or cost. Network processing may include systems and methods for packet processing of packets obtained by a network. Some approaches to network processing may place an emphasis on addressing one or more of the aforementioned needs, where the emphasis may include an associated cost to the other aforementioned needs. For example, focusing on improving cost and/or performance may result in decreased scalability and/or functional flexibility.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a network processing system includes an interface connection to obtain a packet. The network processing system also includes one or more packet processing components individually connected to a system communication channel. The one or more packet processing components are individually configured to perform a packet processing operation to the packet. The network processing system also includes a queueing system connected to the system communication channel. The queueing system determines a processing path of the packet from the interface connection and through the one or more packet processing components. The one or more packet processing components are individually configured to direct the packet to a next component using the processing path.

In another example, a method includes obtaining a first packet by a queueing system. The method also includes determining a processing path for the first packet to traverse at least a first packet processing component and a second packet processing component by the queueing system. The method further includes directing the first packet to a first queue of the first packet processing component based on the processing path. The method also includes performing a first packet processing operation to the first packet by the first packet processing component. The method further includes directing the first packet to a second queue of the second packet processing component based on the processing path. The method also includes performing a second packet processing operation to the first packet by the second packet processing component.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example environment of a network processing system using a hardware distributed architecture;

FIG. 2 illustrates an example flow of multiple packets through a network processing system using a hardware distributed architecture;

FIG. 3 illustrates a flowchart of an example method of network processing using a hardware distributed architecture; and

FIG. 4 illustrates a diagrammatic representation of a machine in the example form of a computing device.

### DETAILED DESCRIPTION

Some existing network processing systems set out to improve one or more aspects of the network processing (e.g., increased performance, scaling based on utilization thereof, interoperability, functional flexibility, power efficiency, and/or cost), but the improvements may be at the expense of the other aspects of the network processing. For example, two existing approaches include a hardware pipe architecture (HPA) and a firmware distributed architecture (FDA).

The HPA system may be arranged as a pipe, or a processing sequence, which may include a physical pipe. The HPA system may be arranged such that incoming packets may be obtained at incoming ports and processed sequentially by a number of processing components included in the HPA system. All packets pass through each of the processing components with consideration as to which processing operations may be employed or not employed to each of the packets. As such, the HPA system may include simple structure that be efficient in terms of an amount of hardware that is used in the processing operations, the connectivity between the processing components (and the incoming ports), and the overall complexity of the HPA system.

Some downsides to the HPA approach include a pipe redesign and/or an architectural redesign when any new processing stage is added; rigid packet flow through the processing components due to the pipe design of HPA systems, which may cause large processing efforts and/or time for even small operations (e.g., a single packet that needs a second classification operation must be passed through all of the processing components of the HPA system for the single classification operation); and/or scaling the HPA may require redesign and/or duplication of the processing components, increasing hardware components and/or costs associated therewith.

Further, sharing of resources that may be used in processing components may not be possible in the HPA systems. For example, in instances in which a first HPA system includes a high-performance processing component (e.g., a high-performance classifier) and a second HPA system includes a similar, but non-high-performance processing component, the second HPA system may not be able to utilize the high-performance processing component as the high-performance processing component may be limited to use in the first HPA system.

The FDA system may be arranged as a hub-like system, where one or more central processing units (CPUs) may be configured to receive incoming traffic and each individual CPU can perform most or all of the processing operations for any particular packet. As such, no rigid set of stages may need be followed as part of the packet processing (e.g., as no pipe is included like the HPA system) and the FDA system may be scale up or scale down as needed.

A downside associated with the FDA system includes the amount of hardware that may be needed to perform the operations (especially relative to the HPA system described herein), where the amount of hardware may increase costs associated with processing packets in the FDA system, such as measured by the area of the HPA system (e.g., a cost of the physical components) and/or the power consumed by the HPA system components. Alternatively, or additionally, components (e.g., the CPUs) in the FDA system may be less suitable for power saving, as powering up and powering down the CPUs may be at least an order of magnitude slower than the hardware components included in the HPA system. For example, power up and power down sequences may take approximately 25 microseconds for a CPU (in an FDA system) and may take approximately 2 microsecond for a processing component (in an HPA system), which may cause a larger buffer to be needed for the FDA system as well.

In general, the HPA approach and the FDA approach may experience one or more challenges associated with scalability (including development time and incorporating new components/CPUs), interoperability (e.g., packets from Ethernet devices, Wi-Fi devices, data over cable service interface specification (DOCSIS) devices, passive optical network (PON) devices, etc.), functional flexibility (e.g., impacts to operational availability in view of changes to the system), and/or cost (e.g., effects of scaling up or scaling down in terms or power, area, and/or speed), as described herein.

In some aspects of the present disclosure, a network processing system may include multiple packet processing components connected to a system communication channel. Further, the network processing system may include a queueing system that may obtain packets (e.g., using one or more ingress ports), determine a processing path for the packets through the multiple packet processing components, and transmit portions of the processing path individually to the multiple packet processing components. As such, the network processing system of the present disclosure may be configured to scale up and down by adjusting the number of packet processing components, which may result in improved power performance, decreased costs, and/or functional flexibility. Alternatively, or additionally, the packet processing components of the network processing system may perform packet processing operations (as opposed to individual CPUs), which may maintain a performance improvement relative to some prior approaches described above.

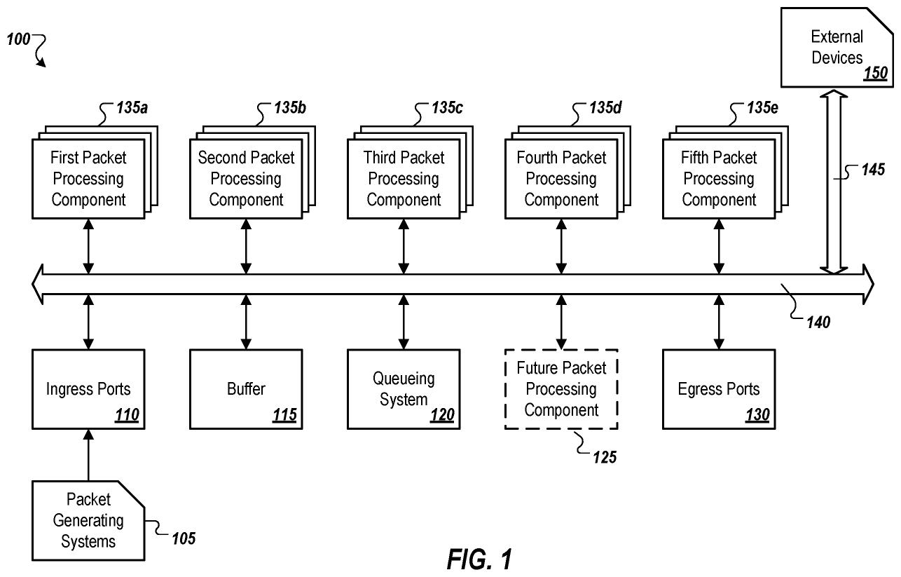

FIG. 1 illustrates an example network processing system 100 (or system 100) using a hardware distributed architecture (HDA), in accordance with at least one embodiment of the present disclosure. The system 100 may include ingress ports 110, a buffer 115, a queueing system 120, a future packet processing component 125, egress ports 130, a first packet processing component 135a, a second packet processing component 135b, a third packet processing component 135c, a fourth packet processing component 135d, a fifth packet processing component 135e, collectively referred to as packet processing components 135, a system communication channel 140, and an external communication channel 145.

The system communication channel 140 may be coupled to one or more of the components included in the system 100 and may facilitate communications between the components, which may include transferring data and/or packets between the components. For example, the system communication channel 140 may be a bus (e.g., a main interconnect bus), a crossbar, and/or a network-on-a-chip (NOC). For example, the ingress ports 110, the buffer 115, the queueing system 120, the egress ports 130, and the packet processing components 135 may be connected to one another (and configured to transmit data and/or packets) via the system communication channel 140.

The ingress ports 110 may be configured to receive incoming packets that may be generated by one or more packet generating systems 105. The combination of the ingress ports 110 and the packet generating systems 105 may be referred to as the interface connection, as the combination thereof may provide an interface between the system 100 and systems and/or devices that generate the packets used in the system 100.

The packet generating systems 105 may include one or more systems or devices that may generate and/or forward packets to be obtained by the system 100 via the ingress ports 110. The packet generating systems 105 may include an Ethernet device, a Wi-Fi device, a data over cable service interface specification (DOCSIS) device, a passive optical network (PON) device, and/or other packet generating systems or devices. The system 100 may include dedicated ingress ports 110 that may correspond to the packet generating systems 105. For example, a first ingress port may be configured to receive packets from an Ethernet device, a second ingress port may be configured to receive packets from a Wi-Fi device, and so forth.

The ingress ports 110 may be configured to support the reception of a predetermined number of packets per second. For example, a first ingress port of the ingress ports 110 may support the reception of approximately 100 k packets per second. In instances in which the number of packets to be received by the system 100 exceeds the capabilities of the first ingress port (e.g., more than 100 k packets per second), one or more additional ingress ports may be added to the ingress ports 110 to support the additional packets.

As the ingress ports 110 obtains packets from the packet generating system 105, the ingress ports 110 may direct the packets to be stored in the buffer 115. As the obtained packets are stored in the buffer 115, the ingress ports 110 may assign a descriptor (e.g., a packet descriptor) to each obtained packet, where the packet descriptor may be used to direct the obtained packet through the system 100, such as to the queueing system 120 and/or to the packet processing components 135 thereafter (e.g., a subsequent packet processing component), as described herein. The queueing system 120 may obtain the packet descriptor associated with the obtained packet from the ingress ports 110 and may determine a processing path for the packet through the system 100, as described herein. A packet descriptor may be created at any time, including when a packet is introduced to the system 100. For ease in explanation, a “packet descriptor” is referred to herein with the understanding that any type of descriptor, for any purpose, may be used with the present disclosure.

Alternatively, or additionally, the obtained packets may be obtained by a portion of the queueing system 120, where the queueing system 120 may determine a processing path for the packet through the system 100, as described herein. Alternatively, or additionally, the obtained packets may be obtained by an individual packet processing queue associated with the packet processing components 135, where the obtained packets may be retrieved from the individual packet processing queue and may be processed by the associated packet processing components 135. In general, the queueing system 120 may be an individual component (e.g., as illustrated as the queueing system 120 in FIG. 1), may be included as logic portions of the packet processing components 135, and/or may be a combination of both. For example, the queueing system 120 may be an individual component to perform a first operation to a particular packet (e.g., a learning operation and/or determining a packet descriptor associated with the particular packet), and the queueing system 120 included as a logic portion of the packet processing components 135 may perform a second operation to the particular packet, such as determining a subsequent packet descriptor for directing the particular packet through the system 100.

The buffer 115 may include any storage device that may be used to store the packets obtained from the ingress ports 110. For example, the buffer 115 may be a database used to store the packets until the packets are transferred through one or more of the packet processing components 135 in the system 100, and subsequently to the egress ports 130 and out of the system 100. The egress ports 130 may include connections to other devices that may use the processed packets, such as hardware devices, processing devices, and the like. For example, the egress ports 130 may provide direct memory access to one or more subsystems, such that the one or more subsystems may obtain the packets processed by the system 100.

The queueing system 120 may include at least a queue manager and a buffer manager. The buffer manager may arrange one or more memory buffers (e.g., pools of memory buffers) and/or supply the memory buffers to the packet processing components 135 based on various rules. For example, the buffer manager may assign a first number of memory buffers to a first packet processing component based on a first policy associated with the first packet processing component and the buffer manager may assign a second number of memory buffers to a second packet processing component based on a second policy associated with the second packet processing component. In another example, the buffer manager may assign one or more memory buffers to one or more packet processing components based on a policy of the system 100. Further, the queue manager may be configured to store the packet descriptor and the associated obtained packet as a linked list such that operations associated with the packet descriptor may be imputed to the associated packet.

The queue manager of the queueing system 120 may be configured to access the packet descriptor associated with a particular packet as operations are performed on the packet by the packet processing components 135. For example, for a particular packet processing component, the queue manager may access the packet descriptor associated with the packet a first time to determine a particular packet processing component to which the particular packet is to be directed (e.g., as part of the packet being obtained by the particular packet processing component), and the queue manager may access the packet descriptor a second time to write a new packet descriptor (e.g., that may be used to direct the particular packet to a subsequent packet processing component).

In instances in which the number of packets being processed by the system 100 satisfies a threshold number relative to the queue manager included in the queueing system 120 (e.g., the rate of packets to be processed is a threshold greater than the rate the queue manager is able to process, or the rate of packets to be processed is a threshold less than the rate the queue manager is able to process), the number of queue managers in the queueing system 120 may be scaled up or scaled down accordingly. In instances in which another queue manager is added to the queueing system 120, the multiple queue managers may be distributed laterally or vertically, where the distribution (e.g., lateral or vertical) may be programmable by an operator (e.g., a user) of the system 100.

For example, a lateral distribution may assign a first queue manager to perform operations relative to a first group of the packet processing components 135 (e.g., the first packet processing component 135a and the second packet processing component 135b) and may assign a second queue manager to perform operations relative to a second group of the packet processing components 135 (e.g., the third packet processing component 135c, the fourth packet processing component 135d, and the fifth packet processing component 135e). In another example, a vertical distribution may facilitate the packet processing components 135 to obtain packets using either a first queue manager or a second queue manager, such that the packet processing components 135 may use multiple queues to obtain packets for processing.

Some packets obtained by the system 100 (such as a new packet obtained via the ingress ports 110) may not have a known processing path through the system 100. The processing path may describe the route a particular packet may take through the system 100, which may include which of the packet processing components 135 the packet may be processed by before leaving the system via the egress ports 130. The processing path may include directions for the packets to a particular packet processing component of the packet processing components 135, such as using the packet descriptor, after which, the packet processing components 135 may update the packet descriptor to direct the packet to a subsequent packet processing component and/or to the egress ports 130. In instances in which a packet does not include a processing path, the queueing system 120 may obtain the packet via a learning queue and may perform an analysis to the packet to determine the processing path through the system 100 for the packet, such as to a particular packet processing component. Subsequently, the particular packet processing component may determine a subsequent packet processing component, and so forth. For example, the queueing system 120 may determine operations to be performed on a first packet may be performed by the first packet processing component 135a, the first packet processing component 135a may determine subsequent processing may be performed by the second packet processing component 135b, and the second packet processing component 135b may determine subsequent processing may be performed by the fifth packet processing component 135e, such that the queueing system 120 and the packet processing components 135 may determine a processing path for the first packet.

In these and other embodiments, the packet processing components 135 may individually include a processing rule table (e.g., a look-up table), which may be used to determine a subsequent packet processing component based on the results of the processing performed therein. The processing rule table may be configurable, such as based on a particular stream of packets, changes to the system 100, changes determined by the queueing system 120, and so forth. Alternatively, or additionally, the look-up table may be updated in the packet processing components 135 based on instructions obtained from the queueing system 120.

The learning queue may store packets obtained using the ingress ports 110 that may not yet have a processing path, such as when a new stream of packets is obtained by the system 100. The learning queue may be utilized by the system 100 to determine how to process the packets included in a particular stream of packets. For example, a first packet and a second packet from a first packet stream may be obtained using the ingress ports 110 and may be stored in the learning queue (as neither the first packet nor the second packet may have a processing path). The queueing system 120 may obtain the first packet (or a packet descriptor associated with the first packet, as described herein) from the learning queue, determine an associated processing path for the first packet, and the queueing system 120 may move the first packet to a queue based on the processing path. Subsequently, the queueing system 120 may be configured to perform queueing operations to the second packet based on the learning performed on the first packet of the first stream.

In general, the queueing system 120 may include at least one computing device that may be configured to perform the operations relative to the queueing system 120 described herein. In the present disclosure, reference to the queueing system 120 performing an operation may be accomplished using the computing device included therein, unless described otherwise. The queueing system 120 may determine a processing path for each packet descriptor that may be associated with any packet received by the system 100. For example, a first packet assigned a first packet descriptor, a second packet assigned a second packet descriptor, and a third packet assigned a third packet descriptor, and the queueing system 120 may determine a first processing path corresponding to the first packet descriptor, a second processing path corresponding to the second packet descriptor, and a third processing path corresponding to the third packet descriptor. In some embodiments, a single descriptor may be used for more than one packet and/or for a group of packets.

As the queueing system 120 determines the processing paths for the packet descriptors associated with the packets, the queueing system 120 may transmit at least a portion of a particular processing path to the packet processing components 135 that may be included in the particular processing path. For example, in instances in which a first packet descriptor includes a processing path that includes a route from the first packet processing component 135a to the second packet processing component 135b and to the fourth packet processing component 135d, the queueing system 120 may transmit the following instructions to the appropriate packet processing components:
to the first packet processing component 135a: upon completion, a packet associated with the first packet descriptor should be forwarded to the second packet processing component 135b;
to the second packet processing component 135b: upon completion, a packet associated with the first packet descriptor should be forwarded to the fourth packet processing component 135d; and
to the fourth packet processing component 135d: upon completion, a packet associated with the first packet descriptor should be forwarded to the egress ports 130.

In such instances, the queueing system 120 may direct the processing flow of the packets by transmitting the instructions corresponding to the packet descriptors associated with the packets to the packet processing components 135. Subsequent to packet processing operations performed by the packet processing components 135, the packet processing components 135 may update the packet descriptors to direct the packets to subsequent packet processing components. Therefore, any particular packet may be directed to an appropriate packet processing component according to the associated packet descriptor and/or the processing path associated with any particular packet may be updated as needed or desired by the queueing system 120 and/or the packet processing components 135 updating the processing flow. In instances in which the queueing system 120 determines updates to the processing flow, the queueing system 120 may transmit the instructions to the packet processing components 135 as described. In general, the instructions transmitted from the queueing system 120 to the packet processing components 135 may be a look-up table, elements of a look-up table, and/or other stored instructions to direct a particular packet processing component to direct a packet to a subsequent packet processing component of the packet processing components 135 and/or the egress ports 130.

Using the processing path as described, the queueing system 120 may be configured to direct some packets on a particular path through the system 100 (e.g., through the packet processing components 135). Further, in instances in which multiple packet processing components configured to perform the same or similar packet processing operation as present in the system 100, the processing path determined by the queueing system 120 may direct a particular packet to a particular packet processing component and/or may perform operations in order (e.g., and bypass a sequencing operation), any of which may reduce processing operations relative to the existing approaches (e.g., HPA and FDA). For example, in instances in which multiple first packet processing components 135a are included in the system 100 (and may vary in performance capabilities), the processing path may direct a particular packet to a higher performance first packet processing component 135a as opposed to a lower performance first packet processing component 135a, which may be based on availability of the first packet processing components 135a, a priority of the particular packet relative to other packets, etc.

The packet processing components 135 may be individually configured to perform a packet processing operation to obtained packets. For example, the packet processing components 135 may be configured to perform a parsing operation, a classifying operation, a metering operation, a sequencing operation, a modifying operation, and/or other packet processing operations. The packet processing components 135 may be configured to obtain packets from a queue, such as a queue individually associated with the packet processing operation. For example, the first packet processing component 135a that performs a parsing operation as the packet processing operation, may obtain packets from a first queue (e.g., a parsing queue), the second packet processing component 135b that performs a classifying operation as the packet processing operation, may obtain packets from a second queue (e.g., a classifying queue), and so forth.

In some embodiments, the packet processing components may obtain a packet on which to perform a packet processing operation from an associated queue based on the packet processing operation. For example, the first packet processing component 135a, which may be configured to perform a parsing operation, may obtain a packet from a parsing queue, and a second packet processing component 135b, which may be configured to perform a classifying operation, may obtain a packet from a classifying queue.

Alternatively, or additionally, in instances in which more than one similar packet processing components, configured to perform a particular packet processing operation (e.g., a first first packet processing component 135a and a second first packet processing component 135a, both configured to perform a parsing operation) are present in the system 100, the similar packet processing components may be configured to operate using a shared queue. For example, a first parsing component and a second parsing component may be configured to using a parsing queue to obtain packets for processing (e.g., to perform a parsing operation thereto).

In general, the packet processing components 135 may be scaled up or down, such as in view of a utilization and/or system requirement(s) thereof. For example, in instances in which the first packet processing component 135a is unable to process packets at a rate equal to or greater than a rate which packets are sent to the first packet processing component 135a, the queueing system 120 may determine a second first packet processing component 135a may be added to the system 100 to increase the packet processing operations associated with the first packet processing component 135a. The scaling of the number of packet processing components 135 may be up (e.g., more packet processing components) or down (e.g., less packet processing components) as determined by the queueing system 120, such as in view of the utilization of any of the packet processing components 135.

In instances in which the packet processing components 135 are scaled up or scaled down, the queueing system 120 may be configured to reconfigure the power to a particular packet processing component. For example, in instances in which a utilization threshold associated with a particular packet processing component indicates the particular packet processing component is underutilized (e.g., the number of packets processed by the particular packet processing component is below a threshold rate relative to a maximum number of packets that may be processed by the particular packet processing component), the queueing system 120 may direct the power provided to the particular packet processing component to be removed, such that the particular packet processing component may not be functional.

In another example, in instances in which a utilization threshold associated with a first packet processing component indicates the first packet processing component is overutilized (e.g., the number of packets processed by the first packet processing component is above a threshold rate relative to a maximum number of packets that may be processed by the first packet processing component), the queueing system 120 may direct power to be provided to a second packet processing component, such that the second packet processing component may be functional and may begin to process packets along with the first packet processing component.

In general, the utilization threshold may be preprogrammed (e.g., predetermined prior to packet processing operations) or the utilization threshold may be reprogrammable, such as by a user via a user interface. For example, the user may determine that power reconfigurations are occurring more frequently than desired (or more frequently than needed to satisfy a desired efficiency or other metric), and the user may reprogram the utilization threshold to be higher (or lower) via a user interface and the queueing system 120. For example, the user may determine a new utilization threshold, input the new utilization threshold into the queueing system 120 via the user interface, and the queueing system 120 may write the new utilization threshold to the packet processing components 135.

An example system to illustrate the power management of the system 100 relative to a HPA system follows. The example system may include eight ingress ports, where each of the ingress ports are configured to support 10G transmissions. As such, the example system may be capable of 80G (e.g., 8*10G=80G). Further, the example system may include a first port at 100% capacity and a second through eighth ports each at 5% capacity. The load of the example system represented as data may be equal to 13.5G (e.g., 10G+7*10G*5%=13.5G) and the load of the example system represented as a percent of a maximum load may be approximately 17% (e.g., 13.5G/80G). Assuming that in the example system, each port is capable of handling 10G speeds, the example system includes five packet processing components, and each of the packet processing components uses an equivalent amount of power (e.g., 10 mw), a comparison of an HPA implementation versus a HDA system similar to the system 100 may be made. For example, the power consumption of an HPA system may be approximately 400 mw, determined based on the eight ports, the five functions, and the 10 mw per function (e.g., 8*5*10 mw=400 mw). In another example, an HDA system may be approximately 100 mw, determined based on two ports (e.g., two ports would provide 20G, which is greater than the 13.5G load of the example system), the five functions, and the 10 mw per function (e.g., 2*5*10 mw=100 mw). As such, the HDA system is configured to reduce a power consumption relative to HPA systems (and other existing solutions) by enabling and disabling ports, processing components, and/or other aspects of the system as needed, such as based on a utilization of components of the system.

In these and other embodiments, the packet processing components 135 that are configured to perform the same or similar packet processing operation as one another (e.g., multiple parsing components) may be arranged to share resources between one another. The resources that may be shared may include, but not be limited to, databases, lookup tables, configuration tables, buffer devices, and/or other resources. For example, multiple packet processing components may be configured to utilize a shared packet processing operation queue, and/or instructions obtained related to a lookup table for forwarding processed packets may be shared among the packet processing components 135 that perform the same or similar packet processing operation.

The queues associated with the packet processing components 135 may be configured to receive packets that may be pushed from the ingress ports 110, the buffer 115, the queueing system 120, and/or the packet processing components 135 (e.g., following a packet processing operation performed by a first packet processing component, the first packet processing component may push the packet to a queue associated with a second packet processing component). As described herein, the packets may be generated by different sources, such as Ethernet devices, Wi-Fi devices, DOCSIS devices, and/or PON devices. In such instances, the packet processing components 135 may be configured to perform the packet processing operation to an obtained packet regardless of the source of the packet. For example, in instances in which the first packet processing component 135a performs a parsing operation, the first packet processing component 135a may perform the parsing operation on a first packet generated using an Ethernet device, and/or a second packet generated using a DOCSIS device.

A particular packet processing component of the packet processing components 135 may transmit a ready signal to the queueing system 120 to indicate the particular packet processing component is ready for a packet to perform the packet processing operation on. In response to obtaining the ready signal, the queueing system 120 may push a packet to the particular packet processing component (e.g., the packet may be pushed from a packet processing operation queue specific to the particular packet processing component or the packet may be pushed from a default queue, that may be stored in the buffer 115).

The packet processing components 135 may individually include a storage portion that may be used to store one or more packets to be processed by the packet processing components 135. Alternatively, or additionally, the packet processing components 135 may individually store the packet descriptors associated with the packets and a separate storage device may store the packets (e.g., the buffer 115, the external devices 150, and/or other storage devices). The storage portion may be arranged to store multiple packets and/or packet descriptors, the number of which may be known by the queueing system 120. For example, the queueing system 120 may transmit a request to a packet processing component to respond with a number of packet count corresponding to the number of packets that may be stored by the packet processing component. Further, the packet processing components 135 may individually use the packet count to determine when to transmit the ready signal to the queueing system 120, such as when a threshold relative to the packet count is satisfied.

For example, in instances in which the packet count associated with a particular packet processing component is X, the particular packet processing component may transmit the ready signal to the queueing system 120 when a threshold of X/2 is satisfied. Using the packet count and the associated threshold, a packet processing component may be configured to maintain a constant flow of packets to be processed, which may improve the throughput and/or efficiency of the packet processing component and/or the system 100. The threshold associated with determining when to transmit the ready signal may be predetermined or preprogrammed into the packet processing components 135. Alternatively, or additionally, a user of the system 100 may be able to adjust the threshold, such as using a user interface and the queueing system 120 to reconfigure the threshold.

In instances in which multiple packet processing components are available to perform a packet processing operation, each of the multiple packet processing components may transmit a ready signal to the queueing system 120 and the queueing system 120 may push a packet to each of the multiple packet processing components to perform the packet processing operation. In such instances, the queueing system 120 may be responsible for sending packets to the multiple packet processing components, which may reduce or eliminate race conditions between the multiple packet processing components obtaining packets. Such circumstances may exist when the system 100 is a stateless system, such that processing of particular packets may not depend on the processing of previous packets. In instances in which the system 100 is not stateless (e.g., a stateful system, where the processing of particular packets depend on the processing of previous packets), a sequencing operation may be performed on the packets, such as by a sequencing component and/or portions of the packet processing components 135, as described herein.

Alternatively, or additionally, the particular packet processing component may pull a packet from the queue (e.g., either from the packet processing operation queue or the default queue) when the particular packet processing component is available to perform a packet processing operation. In instances in which multiple packet processing components are available to perform a packet processing operation, each of the multiple packet processing components may pull a packet from the queue once the packet processing component is available to perform the packet processing operation.

The packet processing components 135 may be configured to perform an associated packet processing operation on an obtained packet. Upon completion of the packet processing operation, the packet processing components 135 may generate a process result. The process result may be a vector that may provide instructions for directing the packet to a next packet processing operation queue. For example, upon completing a packet processing operation, the first packet processing component 135a may generate a process result, which may direct the forwarding of the packet to a subsequent packet processing component, such as the third packet processing component 135c (e.g., the packet processing operation queue associated with the third packet processing component 135c), based on the packet descriptor and/or the processing path associated with the packet. The directions to forward the packet from the first packet processing component 135a to the third packet processing component 135c based on the packet descriptor and/or the processing path may be obtained from the queueing system 120, as described herein.

The vector may include the process result and an error code. The error code may be generated as a result of the packet processing operation and may provide an indication of unexpected operations and/or results related to the packet and the packet processing operation. The error code may be used to determine packets to discard, to supply debug information related to the packets, to determine a subsequent processing path for the packets, and/or other operations associated with the flow of packets through the system 100. In some instances, the vector may be a concatenation of the error code and the process result.

In general, the packet processing components 135 may include a lookup table that may be used to forward a packet to a subsequent packet processing component or the egress ports 130. The lookup table may be programmable in view of the packet descriptor and/or the processing path, such as by the queueing system 120. For example, upon determining the processing path for a packet (e.g., using the packet descriptor, as described herein), the queueing system 120 may transmit instructions to the packet processing components 135 where the instructions may be used to program the lookup table. The programmed lookup table may then be used by the packet processing components 135 to forward packets to a subsequent packet processing component or the egress ports 130, as described herein.

The vector generated during the packet processing operation may compared to the lookup table to determine where the packet may be forwarded. In instances in which the vector is not matched to a subsequent destination (e.g., a packet processing component 135 or the egress ports 130), the packet may be forwarded to a default queue, where the queueing system 120 may determine the subsequent destination for the packet. The default queue may be stored in the buffer 115 and/or any other storage device and may be managed by the queueing system 120 to forward packets that may be unsuccessfully forwarded using the functionality described herein.

The future packet processing component 125 may be illustrative of one or more additional packet processing components that may be added to the system 100, which may be in response to a need or desire to support additional packet processing operations. For example, in instances in which the system 100 is to support encryption and/or decryption of packets, an encryption/decryption packet processing component may be added as the future packet processing component 125. In such instances, the encryption/decryption packet processing component may be connected to the system communication channel 140, may obtain a packet processing operation queue (e.g., the queueing system 120 may generate and/or assign an encryption/decryption packet processing queue), and subsequently, the future packet processing component 125 (e.g., the encryption/decryption packet processing component) may become operational to perform encryption/decryption packet processing operations within the system 100.

The system 100 may be included as part of an electronic chip, such as a microchip, an integrated circuit, etc., where the electronic chip may include one or more processing devices, processing units, engines, systems, etc., which may be generally referred to as external devices 150. In some instances, the system 100 may use the external communication channel 145 to transfer and/or receive data from the external devices 150. For example, in instances in which the system 100 is including encryption as a packet processing operation and the electronic chip includes an encryption engine as an external device 150, the system 100 may use the external communication channel 145 to transfer a packet to the external device 150 (e.g., the encryption engine) and the system 100 may receive an encrypted packet (e.g., the packet processed by the encryption engine) from the external device 150 via the external communication channel 145.

As described herein, the queueing system 120 may include a user interface that may provide a user with an interface to adjust various thresholds associated with the system 100 and/or operations performed by the system 100. Alternatively, or additionally, the user interface may provide a visualization and/or description of one or more statuses associated with the system 100 and/or the components included in the system 100, such as the packet processing components 135. For example, the user interface associated with the queueing system 120 may allow the user to halt the system 100 by user input cause the operations performed by the queueing system 120 to be paused, view the packet processing components 135 to determine utilization (e.g., number of packets processed per time) and/or packet handling therein, insert artificial packets and/or packet descriptors into the system 100 (e.g., such as into one or more of the packet processing components 135), determine if any of the packet processing components 135 may be limited in functionality (e.g., reduced processing speed, halted operations, etc.), and the like. As such, the user interface may allow a user to obtain statistics associated with the system 100, including the queueing system 120, the packet processing components 135, and/or other portions of the system 100. Alternatively, or additionally, the user interface may allow a user to perform debugging operations to the system 100 and/or components of the system 100 using one or more of the aforementioned operations available to the user via the user interface.

Some packets obtained by the system 100 may include order requirements associated with the packets and/or related packets. For example, Ethernet packets need to be ordered during transmission. The system 100 may be configured to perform out of order processing, where the packet processing components 135 may process a packet that may be out of order relative to other associated packets (e.g., the packets may be Ethernet packets that need to be ordered after processing is performed by the system 100). As such, the system 100 may include a packet processing component configured to perform sequencing to the packets. The sequencing component may be one of the packet processing components 135, the future packet processing component 125, and/or one of the external devices 150. In instances in which multiple packet processing components 135 may be configured to perform the same packet processing operation (e.g., multiple parsing components), the sequencing component may be included in the grouping of the multiple packet processing components 135 (e.g., in one of the multiple packet processing components 135 and/or distributed among the multiple packet processing components 135) and may be configured to perform sequencing operations therein.

The sequencing component may obtain the packets (to be sequenced) and may reorder the packets as needed, using a port number and a sequence number that may be assigned to the packets. The port number and/or the sequence number may be assigned to the packets by the queueing system 120 (e.g., the buffer manager or the queue manager) upon being received at the ingress ports 110. As such, the sequencing component may reorder packets as needed and output the reordered packets to the egress ports 130.

The sequencing component may be configured to perform the sequencing based on a maximum latency of the system 100. For example, in instances in which the system 100 (e.g., the buffer 115) holds N jobs, then a worst case reordering to be performed by the sequencing component may be N reorders.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

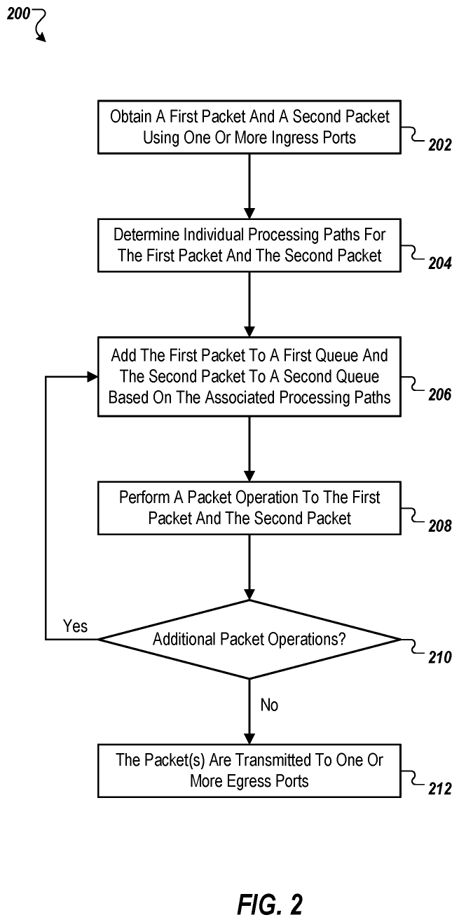

FIG. 2 illustrates an example flow 200 of multiple packets through a network processing system using a hardware distributed architecture, in accordance with at least one embodiment of the present disclosure. The flow 200 may be performed by processing logic that may include hardware (circuitry, dedicated logic, etc.), software (such as is run on a general purpose computer system or a dedicated machine), or a combination of both, which processing logic may be included in any computer system or device, such as the queueing system 120 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 202, a first packet and a second packet may be obtained using one or more ingress ports (e.g., the ingress ports 110 of FIG. 1). The first packet may be obtained using a first ingress port and the second packet may be obtained using the first ingress port or a second ingress port.

At block 204, a first processing path may be determined for the first packet and a second processing path may be determined for the second packet. The first processing path may differ from the second processing path. For example, the first processing path may include a first packet processing component (e.g., one of the packet processing components 135 of FIG. 1), a second packet processing component, and a third packet processing component (including the order of the packet processing components) and the second processing path may include the second packet processing component, the first packet processing component, and a fourth packet processing component.

At block 206, the first packet may be added to a first queue based on the first processing path and the second packet may be added to a second queue based on the second processing path. The first queue may be associated with the first packet processing component and the second queue may be associated with the second packet processing component. In general, each of the packet processing components may include a queue associated therewith.

At block 208, a first packet processing operation may be performed to the first packet by the first packet processing component and a second packet processing operation may be performed to the second packet by the second packet processing component.

At block 210, a determination as to whether additional packet operations are to be performed to the first packet and/or the second packet based on the first processing path and the second processing path, respectively. For example, was the most recent packet processing operation performed to the packet the last packet processing operation included in the processing path. In instances in which there are additional packet processing operations (relative to the first packet and/or the second packet) to be performed, the flow 200 may continue at block 206. In instances in which there are no more packet processing operations to be performed, the flow 200 may continue at block 212.

At block 212, the packets that have finished processing (e.g., the first packet and/or the second packets) may be transmitted to one or more egress ports (e.g., the egress ports 130 of FIG. 1). The egress ports may be used to transmit the packets to other systems or devices and/or may be available for other operations, such as direct memory access.

Modifications, additions, or omissions may be made to the flow 200 without departing from the scope of the present disclosure. For example, the designations of different elements in the manner described is meant to help explain concepts described herein and is not limiting. Further, the flow 200 may include any number of other elements or may be implemented within other systems or contexts than those described.

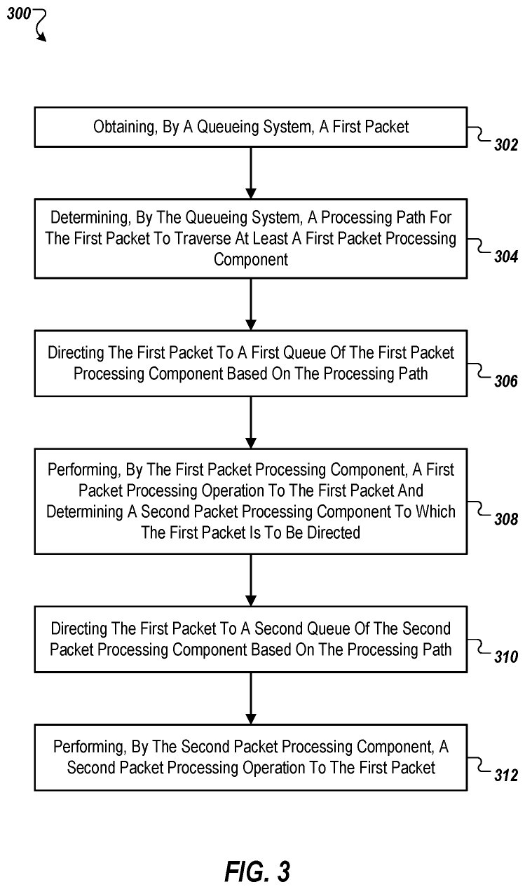

FIG. 3 illustrates a flowchart of an example method 300 of network processing using a hardware distributed architecture, in accordance with at least one embodiment of the present disclosure. The method 300 may be performed by processing logic that may include hardware (circuitry, dedicated logic, etc.), software (such as is run on a general-purpose computer system or a dedicated machine), or a combination of both, which processing logic may be included in any computer system or device such as the queueing system 120 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 302, a first packet may be obtained by a queueing system. In some embodiments, the first packet may be assigned a first packet descriptor. The first packet may be obtained from one of an Ethernet device, a Wi-Fi device, a data over cable service interface specification (DOCSIS) device, or a passive optical network (PON) device.

At block 304, a processing path for the first packet may be determined by the queueing system. Alternatively, or additionally, in instances in which the first packet is assigned a first packet descriptor, a processing path may be determined for the first packet descriptor. The processing path may include traversing at least a first packet processing component. In some embodiments, the first packet may be obtained in a learning queue as part of determining the processing path. Further, the processing path for the first packet may be determined by the queueing system, where the processing path may include at least a first portion and a second portion.

In some embodiments, the first portion and the second portion may be transmitted to respective packet processing components. For example, the first portion may be transmitted to the first packet processing component and the second portion may be transmitted to a second packet processing component.

In some instances, the first packet may be directed to the second queue of the packet processing component by the first packet processing component using the first portion of the processing path. Further, subsequent to the second packet processing operation, the first packet may be directed to an egress port by the second packet processing component using the second portion of the processing path.

In some instances, the first packet may be obtained by an ingress port. The ingress port may assign a first packet descriptor to the first packet and the first packet may be transmitted to the queueing system. The queueing system may be configured to read the packet descriptor and direct the first packet to the first queue at a first time prior to the first packet processing operation. Alternatively, or additionally, the queueing system may be configured to modify the packet descriptor to the first packet at a second time subsequent to the packet processing operation.

At block 306, the first packet may be directed to a first queue of the first packet processing component based on the processing path.

At block 308, a first packet processing operation may be performed to the first packet by the first packet processing component. Alternatively, or additionally, the first packet processing component may determine a second packet processing component to which the first packet may be directed.

At block 310, the first packet may be directed to a second queue of the second packet processing component based on the processing path.

At block 312, a second packet processing operation may be performed to the first packet by the second packet processing component.

In some embodiments, processing statistics of the first packet processing operation and the second packet processing operation may be obtained by the queueing system. In response to the processing statistics associated with the first packet processing component satisfying a first utilization threshold, power to the first packet processing component may be reconfigured by the queueing system. Alternatively, or additionally, in response to the processing statistics associated with the first packet processing component satisfying a second utilization threshold, power to a third packet processing component may be reconfigured by the queueing system.

Modifications, additions, or omissions may be made to the method 300 without departing from the scope of the present disclosure. For example, the designations of different elements in the manner described is meant to help explain concepts described herein and is not limiting. Further, the method 300 may include any number of other elements or may be implemented within other systems or contexts than those described.

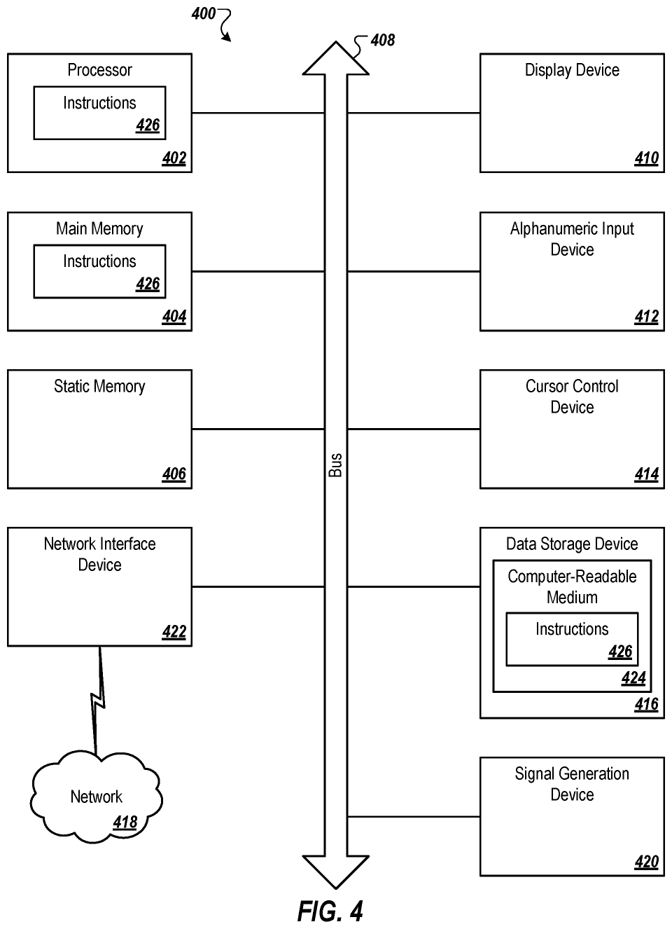

FIG. 4 illustrates a diagrammatic representation of a machine in the example form of a computing device 400 within which a set of instructions, for causing the machine to perform any one or more of the methods discussed herein, may be executed. The computing device 400 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 400 includes a processing device (e.g., a processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

Processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one embodiment, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 426 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open terms” (e.g., the term “including” should be interpreted as “including, but not limited to.”). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A network processing system, comprising:
an interface connection to obtain a packet;
one or more packet processing components individually connected to a system communication channel, the one or more packet processing components individually configured to perform a packet processing operation to the packet; and
a queueing system connected to the system communication channel, the queueing system to determine a processing path of the packet from the interface connection and through the one or more packet processing components, wherein the one or more packet processing components are individually configured to direct the packet to a next component using the processing path.

2. The network processing system of claim 1, wherein the interface connection comprises one or more ingress ports, wherein the ingress ports are configured to obtain the packet from one of an Ethernet device, a Wi-Fi device, a data over cable service interface specification (DOCSIS) device, or a passive optical network (PON) device.

3. The network processing system of claim 2, wherein:
the one or more ingress ports generate a packet descriptor and write the packet descriptor to the packet; and
the queueing system is configured to:
read the packet descriptor and direct the packet to a determined queue at a first time prior to the packet processing operation, and
modify the packet descriptor at a second time subsequent to the packet processing operation.

4. The network processing system of claim 1, wherein the queueing system comprises:
a learning queue to store the packet prior to the packet obtaining the processing path; and
a computing device to determine the processing path and to transmit a portion of the processing path to the one or more packet processing components.

5. The network processing system of claim 4, wherein in response to performing the packet processing operation, the one or more packet processing components are individually configured to generate a process result, use the process result and the processing path to determine a subsequent packet processing component, and forward the packet to a subsequent packet processing operation queue.

6. The network processing system of claim 1, wherein the one or more packet processing components individually comprise a packet processing operation queue based on the packet processing operation performed by the one or more packet processing components.

7. The network processing system of claim 6, wherein a first packet processing component that performs a first packet processing operation and a second packet processing component that performs the first packet processing operation obtain a packet from the same packet processing operation queue.

8. The network processing system of claim 1, wherein the queueing system obtains processing statistics of the one or more packet processing components as the one or more packet processing components individually perform the packet processing operation to the packet and additional packets.

9. The network processing system of claim 8, wherein in response to the processing statistics associated with a particular packet processing component of the one or more packet processing components satisfying a utilization threshold, the queueing system reconfigures power to the particular packet processing component.

10. The network processing system of claim 8, wherein in response to the processing statistics associated with a first packet processing component of the one or more packet processing components satisfying a utilization threshold, the queueing system reconfigures power to a second packet processing component of the one or more packet processing components.

11. The network processing system of claim 8, further comprising a user interface, wherein in response to a first user input, the queueing system provides the processing statistics to the user interface, and in response to a second user input, the queueing system is paused causing the network processing system to halt.

12. A method, comprising:
obtaining, by a queueing system, a first packet;
determining, by the queueing system, a processing path for the first packet to traverse at least a first packet processing component;
directing the first packet to a first queue of the first packet processing component based on the processing path;
performing, by the first packet processing component, a first packet processing operation to the first packet and determining a second packet processing component to which the first packet is to be directed;
directing the first packet to a second queue of the second packet processing component based on the processing path; and
performing, by the second packet processing component, a second packet processing operation to the first packet.

13. The method of claim 12, wherein determining the processing path further comprises:
obtaining the first packet in a learning queue; and
determining, by the queueing system, the processing path for the first packet, the processing path having at least a first portion and a second portion.

14. The method of claim 13, further comprising transmitting the first portion of the processing path to the first packet processing component and the second portion of the processing path to the second packet processing component.

15. The method of claim 14, further comprising:
directing, by the first packet processing component, the first packet to the second queue of the second packet processing component using the first portion of the processing path; and
subsequent to the second packet processing operation, directing, by the second packet processing component, the first packet to an egress port using the second portion of the processing path.

16. The method of claim 12, further comprising:
obtaining, by an ingress port, the first packet;
assigning a first packet descriptor to the first packet; and
transmitting the first packet to the queueing system.

17. The method of claim 12, wherein the queueing system is further configured to:
read the packet descriptor and direct the first packet to the first queue at a first time prior to the first packet processing operation, and
modify the packet descriptor at a second time subsequent to the first packet processing operation.

18. The method of claim 12, further comprising:
obtaining, by the queueing system, processing statistics of the first packet processing operation and of the second packet processing operation; and
in response to the processing statistics associated with the first packet processing component satisfying a first utilization threshold, reconfiguring, by the queueing system, power to the first packet processing component.

19. The method of claim 18, further comprising, in response to the processing statistics associated with the first packet processing component satisfying a second utilization threshold, reconfiguring, by the queueing system, power to a third packet processing component.

20. The method of claim 12, wherein the first packet is obtained from one of an Ethernet device, a Wi-Fi device, a data over cable service interface specification (DOCSIS) device, or a passive optical network (PON) device.
